(19) United States
(12) Patent Application Publication
(10) Pub. No.: US 2021/0201794 A1
(43) Pub. Date: Jul. 1, 2021

(54) PIXEL DRIVING CIRCUIT AND DRIVING METHOD

(71) Applicant: SeeYA Optronics Co., Ltd., Shanghai (CN)

(72) Inventor: Wenwei XU, Shanghai (CN)

(21) Appl. No.: 17/006,668

(22) Filed: Aug. 28, 2020

(30) Foreign Application Priority Data
Dec. 31, 2019 (CN) 201911417995.0

(51) Int. Cl. G09G 3/3258; G09G 3/3291; G09G 3/3266

(52) U.S. Cl. CPC G09G 3/3258; G09G 3/3266; G09G 3/3291

(57) ABSTRACT

Provided is a pixel driving circuit, including: a driving circuit configured to drive a light-emitting device to emit light; a first data writing circuit configured to write, under control of a control signal inputted to its control terminal, an initial voltage into a control terminal of the driving circuit; a second data writing circuit configured to store, under control of a control signal inputted to its control terminal, a voltage difference between an initial grayscale voltage and the initial voltage, and to couple, under control of the control signal, a display grayscale voltage with the voltage difference, so that a voltage of the control terminal of the driving circuit is coupled to a superposition of the display grayscale voltage and the voltage difference; and a storage circuit configured to store a driving voltage of the driving circuit.

### CROSS-REFERENCE TO RELATED APPLICATIONS

The present application claims priority to Chinese Patent Application No. 201911417995.0, filed on Dec. 31, 2019, the contents of which are incorporated herein by reference in its entirety.

### TECHNICAL FIELD

The present disclosure relates to the field of display technologies, and in particular, to a pixel driving circuit and a driving method therefor.

### BACKGROUND

With development of display technologies, display panels and display apparatuses have been widely applied in various areas, and demands for display panels and display apparatuses have increased.

According to a silicon-based active-matrix organic light-emitting diode (AMOLED) micro display technology, an OLED device is directly formed onto a single-crystal silicon integrated circuit chip made by a semiconductor processing process, thereby achieving integration of a pixel driving circuit and a display pixel matrix circuit. However, the performance of the existing pixel driving circuit is still less than ideal, and there is a problem of a small range of a driving voltage thereof.

### SUMMARY

In a first aspect, an embodiment of the present disclosure provides a pixel driving circuit, including: a driving circuit configured to drive a light-emitting device to emit light; a first data writing circuit connected between an initial voltage input terminal and a control terminal of the driving circuit and configured to write, under control of a control signal inputted to a control terminal of the first data writing circuit, an initial voltage into a control terminal of the driving circuit; a second data writing circuit connected between a data signal input terminal and the control terminal of the driving circuit and configured to store, under control of a control signal inputted to a control terminal of the second data writing circuit, a voltage difference between an initial grayscale voltage and the initial voltage, and to couple, under control of the control signal inputted to the control terminal of the second data writing circuit, a display grayscale voltage with the voltage difference, so that a voltage of the control terminal of the driving circuit is coupled to a superposition of the display grayscale voltage and the voltage difference; and a storage circuit electrically connected to the second data writing circuit and configured to store a driving voltage of the driving circuit.

In a second aspect, an embodiment of the present disclosure further provides a driving method for a pixel driving circuit suitable for the pixel driving circuit according to any embodiment of the present disclosure. The driving method for the pixel driving circuit includes: in a first phase, inputting a control signal to a control terminal of the first data writing circuit to control the first data writing circuit to be turned on to write an initial voltage to a control terminal of the driving circuit; and inputting a control signal to a control terminal of the second data writing circuit to control the second data writing circuit to be turned on to store a voltage difference between an initial grayscale voltage and the initial voltage; in a second phase, inputting a control signal to the control terminal of the second data writing circuit to control the second data writing circuit to be turned on to couple a display grayscale voltage with the voltage difference, so that a voltage of the control terminal of the driving circuit is coupled to a superposition of the display grayscale voltage and the voltage difference; and in a third phase, turning on the driving circuit under control of a control terminal of the driving circuit, so as to drive a light-emitting device to emit light.

In the embodiments of the present disclosure, the first data writing circuit writes the initial voltage into the control terminal of the driving circuit under control of the control signal inputted to its input terminal, the second data writing circuit stores the voltage difference between the initial grayscale voltage and the initial voltage under control of the control signal inputted to its control terminal, and couples the display grayscale voltage with the voltage difference, so that the voltage of the control terminal of the driving circuit is coupled to a superposition of the display grayscale voltage and the voltage difference. A value of the initial voltage is adjustable, and a value of the initial grayscale voltage is adjustable. Therefore, a reference value of the grayscale voltage is adjustable, which enlarges a range of the driving voltage, so that the pixel has a larger gamma adjustment range. In addition, according to the embodiments of the present disclosure, there is no need to increase a voltage on the data signal line, thereby facilitating reducing power consumption. Therefore, according to the embodiments of the present disclosure, the range of the driving voltage is enlarged on the basis of the low power consumption. In this way, on the one hand, the range of the driving voltage can be enlarged on the basis of the low power consumption without adjusting the voltage on the data line. On the other hand, the power consumption can be reduced on the basis of a large range of the driving voltage without adjusting the range of the driving voltage.

### BRIEF DESCRIPTION OF DRAWINGS

FIG. 1 is a schematic circuit diagram of a pixel driving circuit in the related art;

FIG. 2 is a schematic circuit diagram of another pixel driving circuit in the related art;

FIG. 3 is a schematic diagram of a layout of a pixel driving circuit in the related art;

FIG. 4 is a schematic diagram of a layout of another pixel driving circuit in the related art;

FIG. 5 is a schematic circuit diagram of a pixel driving circuit according to an embodiment of the present disclosure;

FIG. 6 is a timing sequence diagram of a pixel driving circuit according to an embodiment of the present disclosure;

FIG. 7 is a schematic circuit diagram of another pixel driving circuit according to an embodiment of the present disclosure;

FIG. 8 is a schematic circuit diagram of still another pixel driving circuit according to an embodiment of the present disclosure;

FIG. 9 is a schematic circuit diagram of yet another pixel driving circuit according to an embodiment of the present disclosure;

FIG. 10 is a schematic circuit diagram of yet another pixel driving circuit according to an embodiment of the present disclosure;

FIG. 11 is a schematic circuit diagram of yet another pixel driving circuit according to an embodiment of the present disclosure;

FIG. 12 is a timing sequence diagram of another pixel driving circuit according to an embodiment of the present disclosure;

FIG. 13 is a schematic diagram of a structure of a display panel according to an embodiment of the present disclosure;

FIG. 14 is a schematic diagram of a structure of a display apparatus according to an embodiment of the present disclosure;

FIG. 15 is a schematic flowchart of a driving method for a pixel driving circuit according to an embodiment of the present disclosure; and

FIG. 16 is a schematic diagram showing a gamma adjustment process according to an embodiment of the present disclosure.

### DESCRIPTION OF EMBODIMENTS

The present disclosure will be further described in details in the following with reference to the accompanying drawings and embodiments. It should be understood that the embodiments described herein are intended to illustrate the present disclosure rather than to limit the present disclosure. In addition, it should be noted that, for ease of description, the accompanying drawings merely shows parts but not all structures related to the present disclosure.

As described in the background, the existing pixel driving circuit has a problem that a driving voltage thereof has a small range. Through research, the inventor of the present disclosure has found that this problem was caused by following facts.

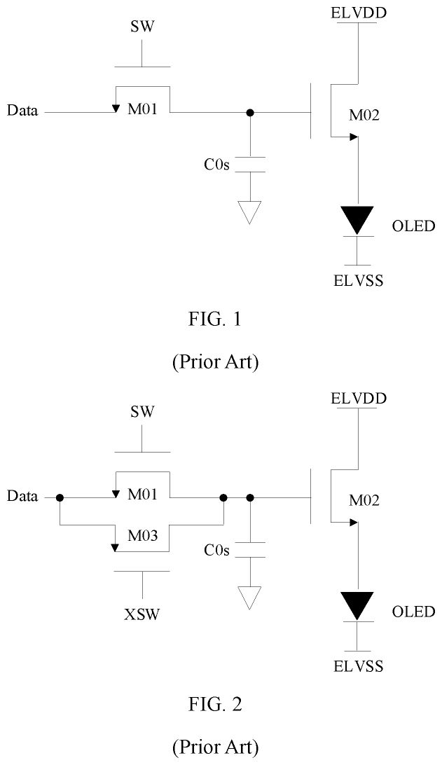

FIG. 1 is a schematic circuit diagram of a pixel driving circuit in the related art. With reference to FIG. 1, the pixel driving circuit is a 2T1C voltage driven pixel circuit. Specifically, the pixel circuit includes a first NMOS transistor M01, a second NMOS transistor M02, and a storage capacitor C0s. The first NMOS transistor M01 includes a gate electrode electrically connected to a first scan signal input terminal SW, a source electrode electrically connected to a data signal input terminal Data, and a drain electrode. The second NMOS transistor M02 includes a gate electrode electrically connected to the drain electrode of the first NMOS transistor M01, a drain electrode electrically connected to a first power supply voltage input terminal ELVDD, and a source electrode electrically connected to a light-emitting device OLED. The storage capacitor C0s includes a first electrode electrically connected to the gate electrode of the second NMOS transistor M02, and a second electrode electrically connected to a reference voltage input terminal. Due to limitation of devices, a data voltage inputted by the data signal input terminal Data is limited. For example, a voltage level of the first NMOS transistor M01 is 8V, and thus a voltage difference applied thereto cannot exceed 8V. In order to ensure that both the first NMOS transistor M01 and the second NMOS transistor M02 operate normally, assuming that a high voltage VGMH inputted by the data signal input terminal Data is 5V, then a level of a data voltage that can be inputted to the gate electrode of the second NMOS transistor M02 is VGMH−Vth_M1, which is approximately 3V. The Vth_M1 is the threshold voltage of the first NMOS transistor M01. Thus, a voltage for driving the pixel ranges only from 0 to VGMH−Vth_M1. It can be seen that a driving voltage received by the gate electrode of the second NMOS transistor M02 ranges within a range smaller than a range from 0 to VGMH.

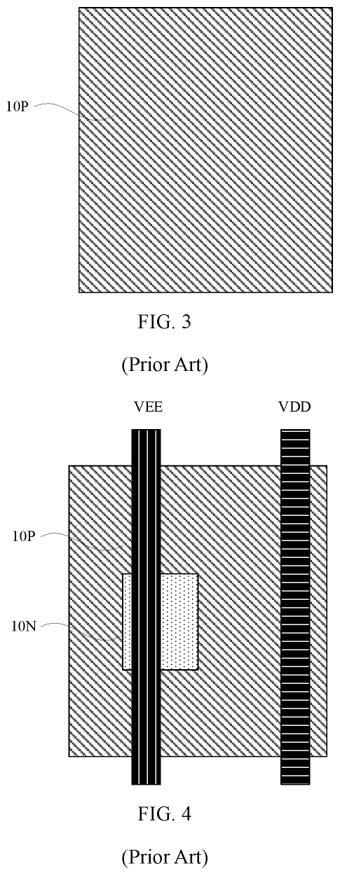

In order to solve the technical problem that the voltage of the 2T1C pixel driving circuit ranges within a small range, a 3T1C pixel driving circuit has been provided in the related art. FIG. 2 is a circuit schematic diagram of another pixel driving circuit in the related art. With reference to FIG. 2, unlike FIG. 1, the pixel driving circuit further includes a first PMOS transistor M03, which is connected in parallel with the first NMOS transistor M01. The first PMOS transistor M03 includes a gate electrode electrically connected to a second scan signal input terminal XSW. A signal level inputted by the first scan signal input terminal SW has a polarity opposite to a signal level inputted by the second scan signal input terminal XSW. The first NMOS transistor M01 and the first PMOS transistor M03 form a transmission gate, and their characteristics are complementary. The high voltage VGMH inputted by the data signal input terminal Data does not lead to a voltage drop on the first NMOS transistor M01 and the first PMOS transistor M03. Therefore, the driving voltage inputted to the gate electrode of the second NMOS transistor M02 ranges from 0 to VGMH. A range of the driving voltage of the 3T1C pixel driving circuit is larger than that of the 2T1C pixel driving circuit, but is still relatively small.

FIG. 3 is a schematic diagram of a layout of a pixel driving circuit in the related art. With reference to FIG. 3, all of the transistors in the pixel driving circuit are NMOS transistors. P-wells are arranged in a region 10P of the layout. Thus, P-wells are all over the layout of the pixel driving circuit.

FIG. 4 is a schematic diagram of a layout of another pixel driving circuit in the related art. With reference to FIG. 4, the transistors in the pixel driving circuit include PMOS transistors and NMOS transistors, and the PMOS transistors and the NMOS transistors form a CMOS. Therefore, when designing a Si-based CMOS layout, P-wells shall be arranged in a region 10P of the layout and N-wells shall be arranged in a region 10N of the layout. Moreover, the P-well corresponds to a high-potential signal line VDD, and the N-well corresponds to a low-potential signal line VEE. Thus, compared with a case in which all of the transistors are NMOS transistors, the layout including both the PMOS and the NMOS requires for more signal lines, which occupy more space, thereby being disadvantageous for achieving a high resolution.

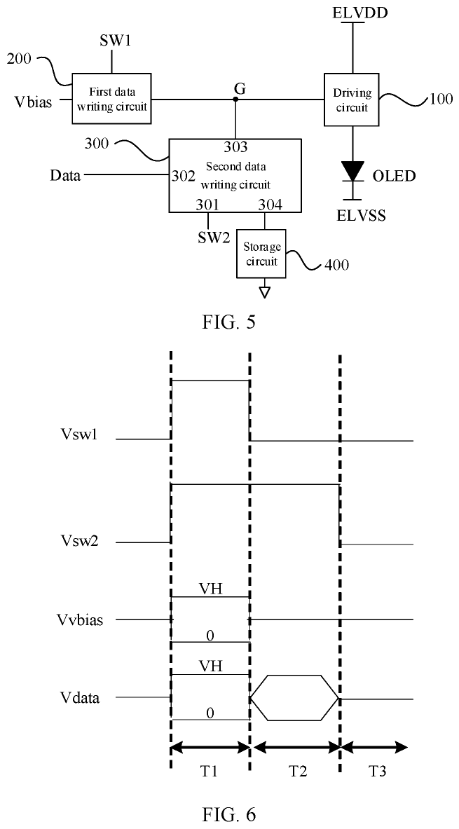

In view of this, embodiments of the present disclosure provide a pixel driving circuit, which is suitable for a silicon-based micro display driving apparatus. FIG. 5 is a schematic circuit diagram of a pixel driving circuit according to an embodiment of the present disclosure. With reference to FIG. 5, the pixel driving circuit includes: a driving circuit 100, a first data writing circuit 200, a second data writing circuit 300, and a storage circuit 400. The driving circuit 100 is configured to drive a light-emitting device OLED to emit light. The first data writing circuit 200 is connected between an initial voltage input terminal Vbias and a control terminal of the driving circuit 100 (a first node G). The first data writing circuit 200 is configured to write an initial voltage into the control terminal of the driving circuit 100 (the first node G) under control of a control signal inputted to its control terminal. The second data writing circuit 300 is connected between the data signal input terminal Data and the control terminal of driving circuit 100 (the first node G). The second data writing circuit 300 is configured to store a voltage difference between an initial grayscale voltage (an initial data voltage) and an initial voltage under control of a control signal inputted by its control terminal, and to couple the display grayscale voltage (data voltage) with the voltage difference, so that a voltage of the control terminal of the driving circuit 100 is coupled to a superposition of a display grayscale voltage and the voltage difference. The storage circuit 400 is electrically connected to the second data writing circuit 300, and is configured to store the driving voltage of the driving circuit 100.

In an example, the driving circuit 100 includes a first terminal electrically connected to the first power supply voltage input terminal ELVDD, and a second terminal electrically connected to a first terminal of the light-emitting device OLED. The second terminal of the driving circuit 100 is electrically connected to a second power supply voltage input terminal ELVSS. The first data writing circuit 200 includes a control terminal electrically connected to a first scan signal input terminal SW1, a first terminal electrically connected to the initial voltage input terminal Vbias, and a second terminal electrically connected to the control terminal of the driving circuit 100 (the first Node G). The second data writing circuit 300 includes a control terminal 301 electrically connected to a second scan signal input terminal SW2, a first terminal 302 electrically connected to the data signal input terminal Data, a second terminal 303 electrically connected to the control terminal of the driving circuit 100 (the first node G), and a third terminal 304 electrically connected to a second terminal of the storage circuit 400. The storage circuit 400 includes a first terminal electrically connected to a first reference voltage input terminal.

FIG. 6 is a timing sequence diagram of a pixel driving circuit according to an embodiment of the present disclosure. With reference to FIG. 6, in an example, a driving timing sequence of the pixel driving circuit includes a first phase T1, a second phase T2, and a third phase T3.

In the first phase T1, i.e., an initialization phase, a first scan signal Vsw1 inputted by the first scan signal input terminal SW1 is at a high level, and a second scan signal Vsw2 inputted by the second scan signal input terminal SW2 is at a high level. The first scan signal Vsw1 controls the first data writing circuit 200 to be turned on, and the initial voltage Vvbias is written into the control terminal of the driving circuit 100 (the first node G). The initial voltage Vvbias at the first node G is 0 or VH. The second scan signal Vsw2 controls the second data writing circuit 300 to be turned on, and a voltage difference between an initial grayscale voltage Vdata and the initial voltage Vvbias is stored, where the initial grayscale voltage Vdata is 0 or VH.

In the second phase T2, i.e., a data writing phase, the first scan signal Vsw1 inputted by the first scan signal input terminal SW1 is at a low level, and the second scan signal Vsw2 inputted by the second scan signal input terminal SW2 is at a high level. The first scan signal Vsw1 controls the first data writing circuit 200 to be turned off. The second scan signal Vsw2 controls the second data writing circuit 300 to be turned on, the voltage difference between the grayscale voltage Vdata and the initial voltage Vvbias is stored, and the display grayscale voltage is coupled with the voltage difference, so that the voltage of the control terminal of the driving circuit 100 (the first node G) is coupled to a superposition of the display grayscale voltage Vdata and the voltage difference. In an example, the initial grayscale voltage Vdata is 0, and the display grayscale voltage Vdata ranges from 0 to VH. In a case in which the initial voltage Vvbias is 0, the driving voltage ranges from 0 to VH. In another case in which the initial voltage Vvbias is VH, the driving voltage ranges from VH to 2*VH. Thus, the driving voltage ranges from 0 to 2*VH.

In the third phase T3, i.e., a light-emitting phase, the first scan signal Vsw1 inputted by the first scan signal input terminal SW1 is at a low level, and the second scan signal Vsw2 inputted by the second scan signal input terminal SW2 is at a low level. The first scan signal Vsw1 controls the first data writing circuit 200 to be turned off, and the second scan signal Vsw2 controls the second data writing circuit 300 to be turned off. The driving circuit 100 is turned on under control of its control terminal (the first node G), so as to drive the light-emitting device OLED to emit light.

It can be seen that according to the embodiments of the present disclosure, the first data writing circuit 200 writes the initial voltage Vvbias into the control terminal of the driving circuit 100 (the first node G) under control of the control signal inputted to its input terminal, and the second data writing circuit 300 stores the voltage difference between the initial grayscale voltage Vdata and the initial voltage Vvbias under control of the control signal inputted to its control terminal, and couples the display grayscale voltage with the voltage difference, so that the voltage of the control terminal of the driving circuit 100 (the first node G) is coupled to a superposition of the display grayscale voltage Vdata and the voltage difference. A value of the initial voltage Vvbias is adjustable, and a value of the initial grayscale voltage is adjustable. Therefore, a reference value of the grayscale voltage Vdata is adjustable, which enlarges a range of the driving voltage, so that the pixel has a larger gamma adjustment range. In addition, according to the embodiments of the present disclosure, there is no need to increase a voltage on the data signal line, thereby facilitating reducing power consumption. Therefore, according to the embodiments of the present disclosure, the range of the driving voltage is enlarged on the basis of the low power consumption. In this way, on the one hand, the range of the driving voltage can be enlarged on the basis of the low power consumption without adjusting the voltage on the data line. On the other hand, the power consumption can be reduced on the basis of a large range of the driving voltage without adjusting the range of the driving voltage.

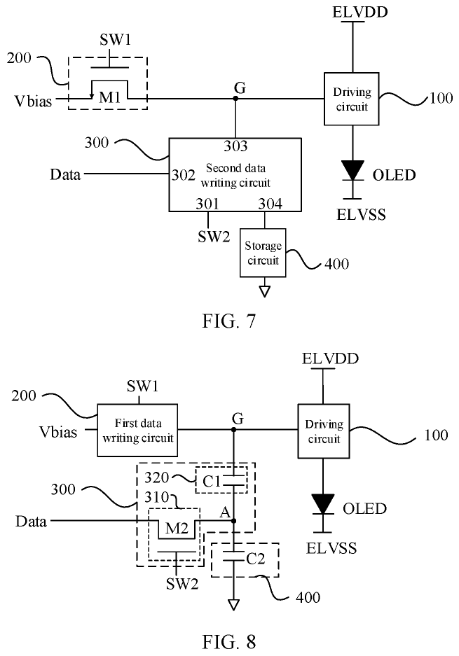

FIG. 7 is a schematic circuit diagram of another pixel driving circuit according to an embodiment of the present disclosure. On the basis of the foregoing embodiments, as an example, the first data writing circuit 200 includes a first transistor M1. The first transistor M1 includes a gate electrode electrically connected to the first scan signal input terminal SW1, a first electrode electrically connected to the initial voltage input terminal Vbias, and a second electrode electrically connected to the control terminal of the driving circuit 100 (the first node G). With such arrangement, the first data writing circuit 200 can have a simple structure, thereby simplifying a circuit design, facilitating a high-resolution layout design, and improving PPI of the display panel.

FIG. 8 is a schematic circuit diagram of still another pixel driving circuit according to an embodiment of the present disclosure. With reference to FIG. 8, on the basis of the foregoing embodiments, as an example, the second data writing circuit 300 includes: a data transmission sub-circuit 310 and a voltage coupling sub-circuit 320. The data transmission sub-circuit 310 includes a control terminal, a first terminal, and a second terminal. The control terminal of the data transmission sub-circuit 310 is electrically connected to the second scan signal input terminal SW2, the first terminal of the data transmission sub-circuit 310 is electrically connected to the data signal input terminal Data, and the second terminal of the data transmission sub-circuit 310 is electrically connected to a first terminal of the voltage coupling sub-circuit 320. The data transmission sub-circuit 310 is configured to transmit the grayscale voltage (including the initial grayscale voltage and the display grayscale voltage) to the first terminal of the voltage coupling sub-circuit 320. The voltage coupling sub-circuit 320 further includes a second terminal electrically connected to the control terminal of the driving circuit 100 (the first node G). The voltage coupling sub-circuit 320 is configured to couple the grayscale voltage of its first terminal with the initial voltage of its second terminal. With such arrangement, the second data writing circuit 300 stores the voltage difference between the initial grayscale voltage Vdata and the initial voltage Vvbias under control of the control signal inputted to its control terminal, and couples the display grayscale voltage with the voltage difference, so that the voltage of the control terminal of the driving circuit 100 (the first node G) is coupled to a superposition of the display grayscale voltage Vdata and the voltage difference.

With further reference to FIG. 8, on the basis of the foregoing embodiments, as an example, the data transmission sub-circuit 310 includes a second transistor M2. The second transistor M2 includes a gate electrode electrically connected to the second scan signal input terminal SW2, a first electrode electrically connected to the data signal input terminal Data, and a second electrode electrically connected to the first terminal of the voltage coupling sub-circuit 320 (a second node A). With such arrangement, the data transmission sub-circuit 310 can have a simple structure, thereby simplifying a circuit design, facilitating a high-resolution layout design, and improving PPI of the display panel.

With further reference to FIG. 8, on the basis of the foregoing embodiments, as an example, the voltage coupling sub-circuit 320 includes a first capacitor C1. The first capacitor C1 includes a first electrode electrically connected to the second terminal of the data transmission sub-circuit 310 (the second node A), and a second electrode electrically connected to the control terminal of the driving circuit 100 (the first node G). The first capacitor C1 is a coupling capacitor capable of storing the voltage difference between the initial grayscale voltage Vdata and the initial voltage Vvbias, and coupling the display grayscale voltage with the voltage difference, so that the voltage of the first node is coupled to a superposition of the display grayscale voltage Vdata and the voltage difference. With such an arrangement, a structure of the voltage coupling sub-circuit 320 is simple, thereby simplifying a circuit design thereof, facilitating a high-resolution layout design, and improving PPI of the display panel.

With further reference to FIG. 8, on the basis of the foregoing embodiments, as an example, the storage circuit 400 includes a second capacitor C2. The second capacitor C2 includes a first electrode electrically connected to a first reference voltage input terminal, and a second electrode electrically connected to the first terminal of the voltage coupling sub-circuit 320 (the second node A). Herein, the second capacitor C2 is a holding capacitor, which can maintain the voltage of the control terminal of the driving circuit 100 (the first node G) unchanged during a light-emission phase. With such arrangement, the storage circuit 400 can have a simple structure, thereby simplifying a circuit design, facilitating a high-resolution layout design, and improving PPI of the display panel.

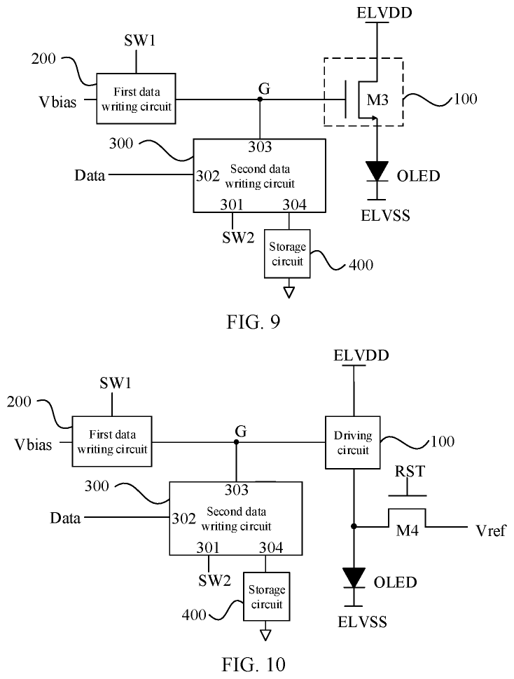

FIG. 9 is a schematic circuit diagram of yet another pixel driving circuit according to an embodiment of the present disclosure. As an example, the driving circuit 100 includes a third transistor M3. The third transistor M3 includes a gate electrode connected to the driving voltage (first node G), a first electrode electrically connected to the first power supply voltage input terminal ELVDD, and a second electrode electrically connected to the light-emitting device OLED. With such arrangement, the driving circuit 100 can have a simple structure, thereby simplifying a circuit design, facilitating a high-resolution layout design, and improving PPI of the display panel.

FIG. 10 is a schematic circuit diagram of yet another pixel driving circuit according to an embodiment of the present disclosure. With reference to FIG. 10, on the basis of the foregoing embodiments, as an example, the pixel driving circuit further includes a fourth transistor M4. The fourth transistor M4 includes a gate electrode electrically connected to a third scan signal input terminal RST, a first electrode electrically connected to a second reference voltage input terminal Vref, and a second electrode electrically connected to an anode of the light-emitting device OLED. The light-emitting device OLED further includes a cathode electrically connected to the second power supply voltage input terminal ELVSS. The fourth transistor M4 is configured to initialize the anode of the light-emitting device OLED under control of its control terminal, which further improves driving stability of the pixel driving circuit and improves a display effect of the display panel.

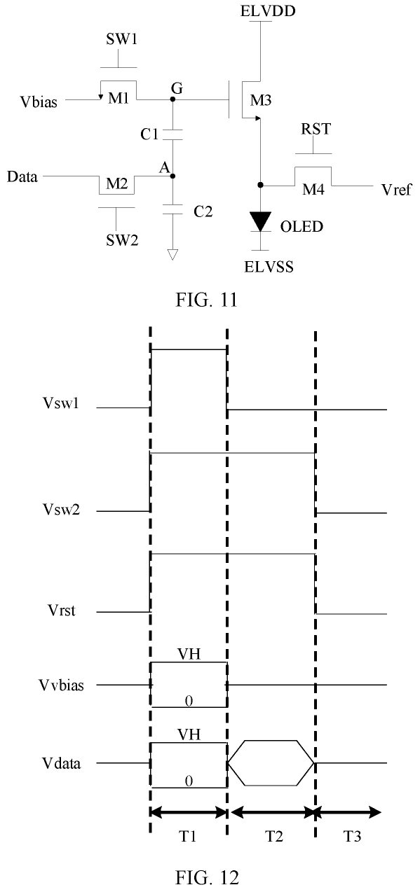

FIG. 11 is a schematic circuit diagram of yet another pixel driving circuit according to an embodiment of the present disclosure. 11. With reference to FIG. 11, on the basis of the foregoing embodiments, as an example, the pixel driving circuit includes: a first transistor M1, a second transistor M2, a first capacitor C1, a second capacitor C2, a third transistor M3 (a driving transistor) and a fourth transistor M4.

The first transistor M1 includes a gate electrode electrically connected to the first scan signal input terminal SW1, a first electrode electrically connected to the initial voltage input terminal Vbias, and a second electrode electrically connected to the first node G.

The second transistor M2 includes a gate electrode electrically connected to the second scan signal input terminal SW2, a first electrode electrically connected to the data signal input terminal Data, and a second electrode electrically connected to the second node A.

The first capacitor C1 includes a first electrode electrically connected to the second node A, and a second electrode electrically connected to the first node G.

The second capacitor C2 includes a first electrode electrically connected to the first reference voltage input terminal, and a second electrode electrically connected to the second node A.

The third transistor M3 includes a gate electrode electrically connected to the first node G, a first electrode electrically connected to the first power supply voltage input terminal ELVDD, and a second electrode electrically connected to the anode of the light-emitting device OLED.

The fourth transistor M4 includes a gate electrode electrically connected to the third scan signal input terminal RST, a first electrode electrically connected to the second reference voltage input terminal Vref, and a second electrode electrically connected to the anode of the light-emitting device OLED. The light-emitting device OLED further includes a cathode electrically connected to the second power supply voltage input terminal ELVSS.

The pixel driving circuit includes 4 transistors and 2 capacitors, forming a 4T2C pixel driving circuit. Herein, the first transistor M1 and the second transistor M2 are data transmission transistors, and the first transistor M1 and the second transistor M2 respectively write the initial voltage and the grayscale voltage to two terminals of the first capacitor C1. The third transistor M3 is a driving transistor and is configured to provide a light-emitting current for the light-emitting device OLED during light emission. The fourth transistor M4 is an anode reset transistor. The first capacitor C1 is a coupling capacitor, and the second capacitor C2 is a holding capacitor.

In an example, the first transistor M1, the second transistor M2, the third transistor M3, and the fourth transistor M4 are all NMOS transistors. The highest switching voltage is VGH for each NMOS transistor. Due to influence of a threshold voltage Vth of a transistor, the highest voltage that can be written into the NMOS transistor is VH, where VH≤VGH−Vth and VH has a lowest value of 0. FIG. 12 is a timing sequence diagram of another pixel driving circuit according to an embodiment of the present disclosure. With reference to FIG. 12, the driving timing sequence of the pixel driving circuit includes a first phase T1, a second phase T2, and a third phase T3.

In the first phase T1, i.e., an initialization phase, a first scan signal Vsw1 inputted by the first scan signal input terminal SW1 is at a high level, a second scan signal Vsw2 inputted by the second scan signal input terminal SW2 is at a high level, and a third scan signal Vrst inputted to the third scan signal input terminal RST is at a high level. The first scan signal Vsw1 controls the first transistor M1 to be turned on, and the initial voltage Vvbias is written into the first node G. An initial voltage of the first node G is 0 or VH. The second scan signal Vsw2 controls the second transistor M2 to be turned on, and the initial grayscale voltage Vdata is written into the second node A. An initial voltage of the second node A is 0 or VH. The third scan signal Vrst controls the fourth transistor M4 to be turned on, and the second reference voltage is written into the anode of the light-emitting device OLED to initialize the anode of the light-emitting device OLED.

In the second phase T2, i.e., a data writing circuit, the first scan signal Vsw1 inputted to the first scan signal input terminal SW1 is at a low level, the second scan signal Vsw2 inputted by the second scan signal input terminal SW2 is at a high level, and the third scan signal Vrst inputted by the third scan signal input terminal RST is at a high level. The first scan signal Vsw1 controls the first transistor M1 to be turned off, and the second scan signal Vsw2 controls the second transistor M2 to be turned on. The grayscale voltage Vdata is written into the second node A, and the voltage of the second node A is Vdata.

In terms of the initial voltage written into the first node G being different from the initial grayscale voltage written into the second node A in the first phase, a voltage coupled to two terminals of the first capacitor C1 is different, and a driving current coupled to the first node G in the second phase is also different. In other words, by adjusting the initial voltage of the first node G or the initial grayscale voltage of the second node A, the range of the driving voltage of the first node G can be adjusted. A specific analysis thereof will be described as follows.

As an example, the initial grayscale voltage remains unchanged at 0. By adjusting a value of the initial voltage, the range of the driving voltage can be enlarged. When the initial voltage is 0, a voltage difference between two terminals of the first capacitor C1 is 0, and the voltage of the first node G will be coupled to 0+(Vdata−0), i.e., Vdata, by the first capacitor C1. The driving voltage of the first node G is a superposition of the initial voltage and the grayscale voltage. Since Vdata is ranges from 0 to VH, the driving voltage of the first node G then ranges from 0 to VH. When the initial voltage is VH, the voltage difference between two terminals of the first capacitor C1 is VH. Then, the voltage of the first node G will be coupled to VH+(Vdata−0), i.e., VH+Vdata, by the first capacitor C1. The driving voltage of the first node G is a superposition of the initial voltage and the grayscale voltage. Since Vdata ranges from 0 to VH, the driving voltage of the first node G then ranges from VH to 2*VH. Therefore, the driving voltage written into the first node G ranges from 0 to 2*VH.

As an example, the initial grayscale voltage maintains unchanged at VH. By adjusting the value of the initial voltage, the range of the driving voltage can be enlarged. When the initial voltage is 0, the voltage difference between two terminals of the first capacitor C1 is −VH, and the voltage of the first node G will be coupled to 0+(Vdata−VH), i.e., (Vdata−VH), by the first capacitor C1. Since Vdata is ranges from 0 to VH, the driving voltage of the first node G then ranges from −VH to 0. When the initial voltage is VH, the voltage difference between two terminals of the first capacitor C1 is 0, and the voltage of the first node G will be coupled to VH+(Vdata−VH), i.e., Vdata, by the first capacitor C1. Since Vdata ranges from 0 to VH, the driving voltage of the first node G then ranges from 0 to VH. Therefore, the driving voltage written into the first node G ranges from −VH to VH.

As an example, the initial voltage remains unchanged at 0. By adjusting the value of the initial grayscale voltage, the range of the driving voltage can be enlarged. When the initial grayscale voltage is 0, the voltage difference between two terminals of the first capacitor C1 is 0, and the voltage of the first node G will be coupled to 0+(Vdata−0), i.e., Vdata, by the first capacitor C1. Since Vdata ranges from 0 to VH, the driving voltage of the first node G then ranges from 0 to VH. When the initial grayscale voltage is VH, the voltage difference between two terminals of the first capacitor C1 is −VH, and the voltage of the first node G will be coupled to 0+(Vdata−VH), i.e., Vdata−VH, by the first capacitor C1. Since Vdata ranges from 0 to VH, the driving voltage of the first node G then ranges from −VH to 0. Therefore, the driving voltage written into the first node G ranges from −VH to VH.

As an example, the initial voltage remains unchanged at VH. By adjusting the value of the initial grayscale voltage, the range of the driving voltage can be enlarged. When the initial grayscale voltage is 0, the voltage difference between two terminals of the first capacitor C1 is −VH, and the voltage of the first node G will be coupled to VH+(Vdata−VH), i.e., Vdata, by the first capacitor C1. Since Vdata ranges from 0 to VH, the driving voltage of the first node G then ranges from 0 to VH. When the initial grayscale voltage is VH, the voltage difference between two terminals of the first capacitor C1 is 0, and the voltage of the first node G will be coupled to VH+(Vdata−0), i.e., Vdata+VH, by the first capacitor C1. Since Vdata ranges from 0 to VH, the driving voltage of the first node G then ranges from VH to 2*VH. Therefore, the driving voltage written into the first node G ranges from 0 to 2*VH.

In the third phase T3, i.e., a light-emitting phase, the first scan signal Vsw1 inputted by the first scan signal input terminal SW1 is at a low level, the second scan signal Vsw2 inputted by the second scan signal input terminal SW2 is at a low level, and the third scan signal Vrst inputted by the third scan signal input terminal RST is at a low level. The first transistor M1 is turned off under control of the first scan signal Vsw1, the second transistor M2 is turned off under control of the second scan signal Vsw2, and the fourth transistor M4 is turned off under control of the third scan signal Vrst. At this time, the third transistor M3 provides a current to the light-emitting device OLED under driving of the driving voltage of its gate electrode (the first node G). Since the driving voltage of the first node G ranges within a large range, the driving current of the third transistor M3 ranges within a large range, and a brightness of the light-emitting device OLED ranges within a large range. Compared with the 2T1C pixel driving circuit and the 3T1C pixel driving circuit, the embodiments of the present disclosure provide a larger gamma adjustment range and a better display effect of the display panel. In addition, since all of the transistors in the pixel driving circuit may be set as NMOS transistors, compared with the CMOS transistor, there is no need to respectively provide high-potential and low-potential control signal lines, which is more advantageous for achieving high resolution of the display panel.

According to the embodiments of the present disclosure, in the first phase T1, the initial voltage is written into the gate electrode of the third transistor M3, the initial grayscale voltage is written into the second node A, and the first capacitor C1 stores the voltage difference between the initial voltage and the initial grayscale voltage. In the second phase T2, depending on different video data, the display controller writes different display grayscale voltages into a terminal of the first capacitor C1, and the first capacitor C1 superposes the display grayscale voltage and the voltage difference. In this case, when the light-emitting device OLED is driven by the third transistor M3 to emit light in the third phase T3, the driving voltage of the third transistor M3 ranges within a large range. Therefore, the driving current of the third transistor M3 ranges within a large range, reducing difficulty in adjusting the gamma voltage. Moreover, according to the embodiments of the present disclosure, the range of the driving voltage is enlarged without increasing the voltage of the grayscale signal. In this way, on the one hand, the range of the driving voltage can be enlarged on the basis of the low power consumption without adjusting the range of the data voltage. On the other hand, the power consumption can be reduced on the basis of a large range of the driving voltage without adjusting the range of the driving voltage. In addition, since all of the transistors in the pixel driving circuit may be set as NMOS transistors, compared with the CMOS transistor, there is no need to respectively provide high-potential and low-potential control signal lines, which is more advantageous for achieving high resolution of the display panel.

It should be noted that, in the above-mentioned embodiments, it is exemplarily shown that the transistors in the pixel driving circuit are all NMOS transistors, but the present disclosure is not limited thereto. In other embodiments, all the transistors of the pixel driving circuit may be PMOS transistors, which can be arranged as needed in practical applications.

It should also be noted that, in the above-mentioned embodiments, it is exemplarily shown that the third scan signal Vrst is at a high level both in the first phase T1 and in the second phase T2, but the present disclosure is not limited thereto. In other embodiments, the third scan signal Vrst may be at a high level only in the first phase T1.

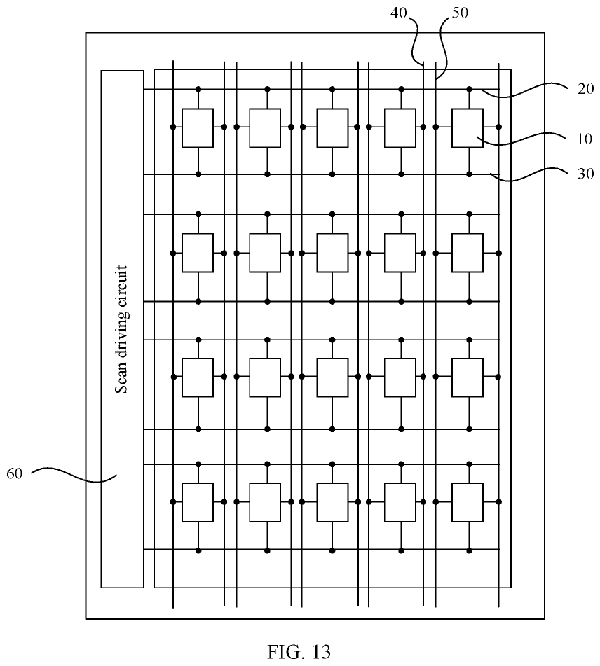

The embodiments of the present disclosure further provide a display panel. FIG. 13 is a schematic diagram of a structure of a display panel according to an embodiment of the present disclosure. With reference to FIG. 13, the display panel includes the pixel driving circuit 10 provided by any embodiment of the present disclosure. A technical principle and a resulting effect thereof are similar to those in the above-mentioned embodiments, and will not be further described herein.

With further reference to FIG. 13, as an example, the display panel further includes a plurality of first scan lines 20, a plurality of second scan lines 30, a plurality of data lines 40, and a plurality of initial voltage signal lines 50. The first scan line 20 is electrically connected to the first scan signal input terminal of the pixel circuit, and the first scan line 20 provides a first scan signal to the pixel circuit electrically connected thereto. That is, the first scan line 20 provides a control signal to the first data writing circuit. The second scan line 30 is electrically connected to the second scan signal input terminal of the pixel circuit, and the second scan line 30 provides a second scan signal to the pixel circuit electrically connected thereto. That is, the second scan line 30 provides a control signal to the second data writing circuit. The initial voltage signal line 50 is electrically connected to the initial voltage input terminal of the pixel circuit, and the initial voltage signal line 50 provides an initial voltage to the pixel circuit electrically connected thereto. The data line 40 is electrically connected to the data signal input terminal of the pixel circuit, and the data line 40 provides a grayscale voltage to the pixel circuit electrically connected thereto.

With further reference to FIG. 13, as an example, the display panel further includes a scan driving circuit 60, and the scan driving circuit 60 is located in a non-display area of the display panel. The plurality of first scan lines 20 and the plurality of second scan lines 30 are electrically connected to the scan driving circuit 60, and both the first scan signal and the second scan signal are provided by the scan driving circuit 60.

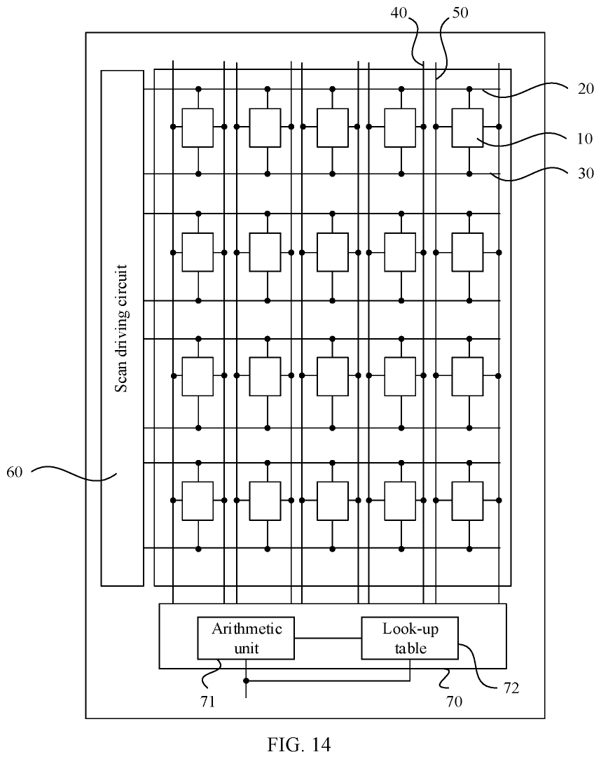

The embodiments of the present disclosure further provide a display apparatus. FIG. 14 is a schematic diagram of a structure of a display apparatus according to an embodiment of the present disclosure. With reference to FIG. 14, the display apparatus includes a display controller 70 and the pixel driving circuit 10 as provided in any embodiment of the present disclosure. The display controller 70 is configured to transmit an initial voltage to the first data writing circuit and transmit a grayscale voltage to the second data writing circuit. The display apparatus includes the pixel driving circuit 10 provided by any embodiment of the present disclosure. A technical principle and a resulting effect thereof are similar to those in the above-mentioned embodiments, and will not be further described herein.

In an example, the display apparatus may be a micro light-emitting diode display apparatus or an organic light-emitting diode display apparatus. The display apparatus may be an electronic device such as a mobile phone, a computer, or a wearable device. A specific form of the display apparatus is not limited in the embodiments of the present disclosure.

With further reference to FIG. 14, as an example, the display controller 70 includes a look-up table 72 and an arithmetic unit 71. When video data is transmitted to the display controller 70, the arithmetic unit 71 and the look-up table 72 search for the initial voltage corresponding to the video data (for example, 0 or VH), and the pixel driving circuit 10 superposes the initial voltage and the grayscale voltage so as to enlarge the range of the driving voltage of the driving transistor. In an example, the look-up table 72 may be formed based on data after gamma burning before the product leaves the factory.

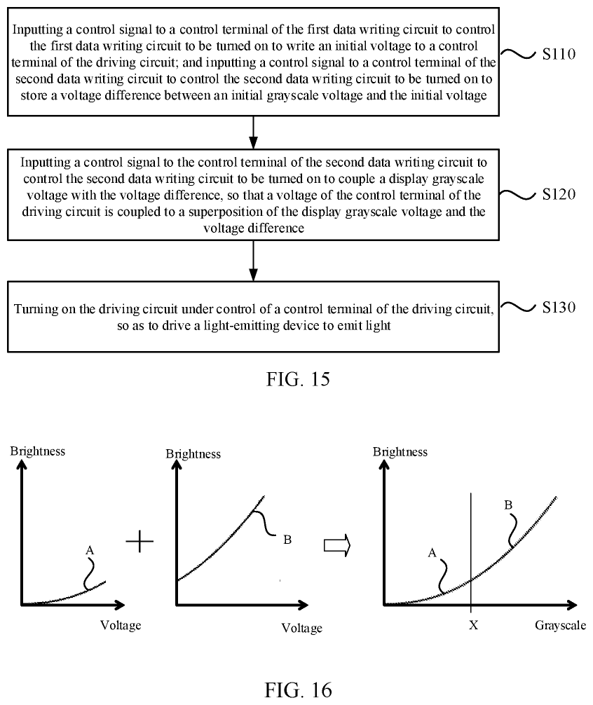

The embodiments of the present disclosure further provide a driving method for the pixel driving circuit, which is suitable for the pixel driving circuit provided by any embodiment of the present disclosure. FIG. 15 is a schematic flowchart of a driving method for a pixel driving circuit according to an embodiment of the present disclosure. With reference to FIG. 15, the driving method for the pixel driving circuit includes the following steps.

At step S110, in the first phase, a control signal is inputted from the control terminal of the first data writing circuit to control the first data writing circuit to be turned on to write an initial voltage into the control terminal of the driving circuit; a control signal is inputted to the control terminal of the second data writing circuit to control the second data writing circuit to be turned on to store the voltage difference between the initial grayscale voltage and the initial voltage.

At step S120, in the second phase, a control signal is inputted to the control terminal of the second data writing circuit to control the second data writing circuit to be turned on to couple the display grayscale voltage with the voltage difference, so that the voltage of the control terminal of the driving circuit is coupled to a superposition of the display grayscale voltage and the voltage difference.

At step S130, in the third phase, the driving circuit is turned on under control of its control terminal, so as to drive the light-emitting device to emit light.

According to the embodiments of the present disclosure, in the first phase, the voltage difference between the initial grayscale voltage and the initial voltage is stored. In the second phase, the display grayscale voltage is coupled with the voltage difference, so that the voltage of the control terminal of the driving circuit is coupled to a superposition of the display grayscale voltage and the voltage difference. A value of the initial voltage and a value of the initial grayscale voltage are adjustable. Thus, a reference value of the grayscale voltage Vdata is adjustable, which enlarges a range of the driving voltage, so that the pixel has a larger gamma adjustment range. In addition, according to the embodiments of the present disclosure, there is no need to increase a voltage on the data signal line, thereby facilitating reducing power consumption. Therefore, according to the embodiments of the present disclosure, the range of the driving voltage is enlarged on the basis of low power consumption. In this way, the range of the driving voltage can be enlarged on the basis of the low power consumption without adjusting the voltage on the data line. On the other hand, the power consumption can be reduced on the basis of a large range of the driving voltage without adjusting the range of the driving voltage.

As an example, the initial voltage includes a first set voltage and a second set voltage, and the first set voltage is smaller than the second set voltage. If the display grayscale is smaller than the preset grayscale, then the initial voltage is the first set voltage. If the display grayscale is greater than the preset grayscale, then the initial voltage is the second set voltage. Herein, the preset grayscale ranges from the minimum display grayscale to the maximum display grayscale.

In an example, the first set voltage is 0V, and the second set voltage is equal to the maximum value of the display grayscale voltage. FIG. 16 is a schematic diagram showing a gamma adjustment process according to an embodiment of the present disclosure. With reference to FIG. 16, a curve A is a gamma adjustment curve when the initial voltage is 0V, and a curve B is a gamma adjustment curve when the initial voltage is the maximum value VH. According to the embodiments of the present disclosure, the gamma adjustment is performed under two conditions of the initial voltage of 0V and the maximum value of VH, so as to achieve full grayscale debugging. Then, the curve A and the curve B are combined to form a complete gamma curve. Each grayscale corresponds to one driving voltage, and such driving voltage includes two parts. One part is an initial voltage having only two values of 0 and VH. The other part is a grayscale voltage required for display. In this way, the driving voltage required for the grayscale corresponding to the brightness is data in the look-up table. Taking a preset grayscale X as a dividing point, when the grayscale is lower than preset grayscale X, the initial voltage is set as 0, and when the grayscale is higher than the preset grayscale X, the initial voltage is set as the maximum value VH. Different values for the subsequent data voltages may be selected depending on different grayscales. After the product leaves the factory, video data will be first inputted into the display controller, and then the corresponding voltage value will be found in the look-up table. The initialized voltage is set based on the range, thereby achieving display at normal grayscales.

As an example, the initial grayscale voltage includes a third set voltage and a fourth set voltage, and the third set voltage is higher than the fourth set voltage. If the display grayscale is smaller than the preset grayscale, then the initial grayscale voltage is the third set voltage. If the display grayscale is greater than the preset grayscale, then the initial grayscale voltage is the fourth set voltage. Herein, the preset grayscale ranges from the minimum display grayscale to the maximum display grayscale.

In an example, the third set voltage is equal to the maximum value of the display grayscale voltage, and the fourth set voltage is 0V.

It should be noted that the above descriptions are merely preferred embodiments of the present disclosure and technical principles applied thereto. Those skilled in the art will understand that the present disclosure is not limited to the specific embodiments described herein. In addition, those skilled in the art may make various obvious changes, readjustments, and substitutions without departing from the scope of the present disclosure. Therefore, although the present disclosure has been described in details through the above embodiments, the present disclosure is not limited to the above embodiments, and may include other equivalent embodiments without departing from the concept of the present disclosure. The scope is determined by the appended claims.

What is claimed is:

1. A pixel driving circuit, comprising:
a driving circuit configured to drive a light-emitting device to emit light;
a first data writing circuit connected between an initial voltage input terminal and a control terminal of the driving circuit and configured to write, under control of a control signal inputted to a control terminal of the first data writing circuit, an initial voltage into a control terminal of the driving circuit;
a second data writing circuit connected between a data signal input terminal and the control terminal of the driving circuit and configured to store, under control of a control signal inputted to a control terminal of the second data writing circuit, a voltage difference between an initial grayscale voltage and the initial voltage, and to couple, under control of the control signal inputted to the control terminal of the second data writing circuit, a display grayscale voltage with the voltage difference, so that a voltage of the control terminal of the driving circuit is coupled to a superposition of the display grayscale voltage and the voltage difference; and
a storage circuit electrically connected to the second data writing circuit and configured to store a driving voltage of the driving circuit.

2. The pixel driving circuit according to claim 1, wherein the first data writing circuit comprises a first transistor, and the first transistor has a gate electrode electrically connected to a first scan signal input terminal, a first electrode electrically connected to the initial voltage input terminal, and a second electrode electrically connected to the control terminal of the driving circuit,
wherein the second data writing circuit comprises a data transmission sub-circuit and a voltage coupling sub-circuit,
the data transmission sub-circuit has a control terminal electrically connected to a second scan signal input terminal, a first terminal electrically connected to the data signal input terminal, and a second terminal electrically connected to a first terminal of the voltage coupling sub-circuit, and the data transmission sub-circuit is configured to transmit the grayscale voltage to the first terminal of the voltage coupling sub-circuit, and
the voltage coupling sub-circuit has a second terminal electrically connected to the control terminal of the driving circuit; and the voltage coupling sub-circuit is configured to couple the grayscale voltage of the first terminal of the voltage coupling sub-circuit with an initial voltage of the second terminal of the voltage coupling sub-circuit, so that a voltage of the second terminal of the voltage coupling sub-circuit is coupled to a superposition of the grayscale voltage and the initial voltage.

3. The pixel driving circuit according to claim 2, wherein the data transmission sub-circuit comprises a second transistor, and the second transistor has a gate electrode electrically connected to the second scan signal input terminal, a first electrode electrically connected to the data signal input terminal, and a second electrode electrically connected to the first terminal of the voltage coupling sub-circuit.

4. The pixel driving circuit according to claim 2, wherein the voltage coupling sub-circuit comprises a first capacitor, and the first capacitor has a first electrode electrically connected to the second terminal of the data transmission sub-circuit, and a second electrode electrically connected to the control terminal of the driving circuit.

5. The pixel driving circuit according to claim 2, wherein the storage circuit comprises a second capacitor, and the second capacitor has a first electrode electrically connected to a first reference voltage input terminal, and a second electrode electrically connected to the first terminal of the voltage coupling sub-circuit.

6. The pixel driving circuit according to claim 1, wherein the driving circuit comprises a third transistor, and the third transistor has a gate electrode connected to the driving voltage, a first electrode electrically connected to a first power supply voltage input terminal, and a second electrode electrically connected to the light-emitting device.

7. The pixel driving circuit according to claim 1, further comprising a fourth transistor, wherein the fourth transistor has a gate electrode electrically connected to a third scan signal input terminal, a first electrode electrically connected to a second reference voltage input terminal, and a second electrode electrically connected to a first electrode of the light-emitting device; and the light-emitting device has a second electrode electrically connected to a second power supply voltage input terminal.

8. A driving method for a pixel driving circuit, the pixel driving circuit comprising a driving circuit, a first data writing circuit, a second data writing circuit, and a storage circuit, the driving method for the pixel driving circuit comprising:
in a first phase, inputting a control signal to a control terminal of the first data writing circuit to control the first data writing circuit to be turned on to write an initial voltage to a control terminal of the driving circuit; and inputting a control signal to a control terminal of the second data writing circuit to control the second data writing circuit to be turned on to store a voltage difference between an initial grayscale voltage and the initial voltage;
in a second phase, inputting a control signal to the control terminal of the second data writing circuit to control the second data writing circuit to be turned on to couple a display grayscale voltage with the voltage difference, so that a voltage of the control terminal of the driving circuit is coupled to a superposition of the display grayscale voltage and the voltage difference; and
in a third phase, turning on the driving circuit under control of a control terminal of the driving circuit, so as to drive a light-emitting device to emit light.

9. The driving method for the pixel driving circuit according to claim 8, wherein the initial voltage comprises a first set voltage and a second set voltage greater than the first set voltage,
the initial voltage is the first set voltage, if a display grayscale is smaller than a preset grayscale,
the initial voltage is the second set voltage if the display grayscale is greater than the preset grayscale, and
the preset grayscale ranges from a minimum display grayscale to a maximum display grayscale.

10. The driving method for the pixel driving circuit according to claim 8, wherein the initial grayscale voltage comprises a third set voltage and a fourth set voltage smaller than the third set voltage,
the initial grayscale voltage is the third set voltage if a display grayscale is smaller than a preset grayscale,
the initial grayscale voltage is the fourth set voltage if the display grayscale is greater than the preset grayscale, and
the preset grayscale ranges from a minimum display grayscale to a maximum display grayscale.
